(19) United States
(12) Patent Application Publication
(10) Pub. No.: US 2018/0123134 A1
(43) Pub. Date: May 3, 2018

(54) Electrochemically Active Interlayers for Lithium Ion Batteries

(71) Applicant: Brookhaven Science Associates, LLC, Upton, NY (US)

(72) Inventors: Hong Gan, Miller Place, NY (US); Ke Sun, Middle Island, NY (US)

(21) Appl. No.: 15/725,501

(22) Filed: Oct. 5, 2017

Related U.S. Application Data
(60) Provisional application No. 62/413,583, filed on Oct. 27, 2016.

(51) Int. Cl. H01M 4/62; H01M 4/131; H01M 4/1397; H01M 10/0525

(52) U.S. Cl. CPC H01M 4/622; H01M 4/131; B01D 71/26; H01M 10/0525; H01M 4/1397

(57) ABSTRACT

This disclosure is geared toward a lithium ion battery cell system. The system includes an anode current collector in contact with an anode, a separator in contact with the anode, an electrolyte, a cathode, an additive layer situated between the separator and the cathode, and a cathode current collector. The additive layer may include at least one of a transition metal sulfide, a transition metal oxide, and a transition metal phosphate.

### CROSS REFERENCES TO RELATED APPLICATIONS

This application claims priority to U.S. provisional application Ser. No. 62/413,583 filed Oct. 27, 2016, the content of which is incorporated herein in its entirety.

### STATEMENT OF GOVERNMENT RIGHTS

This invention was made with Government support under contract number DE-SC0012704 awarded by the U.S. Department of Energy. The Government has certain rights in the invention.

### I. FIELD OF THE INVENTION

This disclosure relates generally to battery cell systems. In particular, it relates to lithium-ion battery cell systems.

II. BACKGROUND

Lithium ion batteries are used as power sources for consumer electronics, including laptops, tablets, and smart phones. The amount of energy stored by weight and/or volume is one way to measure performance in these applications. For larger applications, such as for example electric vehicles, power density may be measured. The batteries should be able to charge and discharge quickly as they react to sudden changes in load during actual driving conditions.

However, the cost of using lithium ion batteries in electric vehicles is high. Even for next generation Li-ion technologies under development, the predicted performance and cost metrics may still be unfavorable. In the past two decades, the chemistries of the lithium ion technologies have been intensively studied and the active material utilization are close to their theoretical limit. The graphite anode in conventional Li-ion batteries has already reached its theoretical capacity (372 mAh/g) with little room for improvement. The same limitation also applies to the layered transition metal oxides intercalation cathodes (˜250-300 mAh/g). While much effort have been devoted to the discovery of the new high energy density materials in recent years, such as alloy type of anodes (e.g. Si or Sn) and Sulfur cathode, as well as multivalent conversion reaction cathodes, the cell systems utilizing these new materials may not perform satisfactory, especially in terms of cycle life, long term stability and reliability.

### SUMMARY

This disclosure is geared toward a lithium ion battery cell system. The system includes an anode current collector in contact with an anode, a separator in contact with the anode, an electrolyte, a cathode, an additive layer situated between the separator and the cathode, and a cathode current collector. The additive layer may include at least one of a transition metal sulfide, a transition metal oxide, and a transition metal phosphate.

### BRIEF DESCRIPTION OF THE DRAWINGS

FIG. 1 schematically illustrates prior art battery cell system.

FIG. 2 schematically illustrates an embodiment of a battery cell.

FIG. 3a schematically illustrates an embodiment of a first sulfur discharge step of a battery cell.

FIG. 3b schematically illustrates an embodiment of a second sulfur discharge step of a battery cell.

FIG. 4a schematically illustrates an embodiment of a first MnO₂ discharge step of a battery cell.

FIG. 4b schematically illustrates an embodiment of a second MnO₂ discharge step of a battery cell.

FIG. 4c schematically illustrates an embodiment of a third MnO₂ discharge step of a battery cell.

FIG. 5 is a graph showing the cell cycling discharge capacities vs. the cycle number for the coin cells using a Control Cathode or a Hybrid Sulfur/TiS₂ Cathode.

FIG. 6 include cell discharge voltage profiles against the percent delivered capacity in embodiments of the invention.

FIG. 7 is a graph showing sulfur discharge efficiency according to embodiments of the invention.

FIG. 8 is a graph showing the the cycling capacity retention according to embodiments of the invention.

FIG. 9 is a graph showing the cyclic voltammetry (CV) performed on a embodiment of a coin cell with γ-MnO₂ cathode.

FIG. 10 is a graph showing the 1^{st} cycle discharge and charge voltage profiles of embodiments of the invention.

FIG. 11 is a graph showing the cell cycling behavior over 35 cycles of an embodiment.

FIG. 12 is a graph showing the first discharge voltage profiles vs. the theoretical capacity of embodiments of the invention.

FIG. 13 is a graph showing the second discharge voltage profiles vs. the theoretical capacity of embodiments of the invention.

FIG. 14 is a graph showing the sulfur utilization vs. the cycle number of embodiments of the invention.

### DETAILED DESCRIPTION

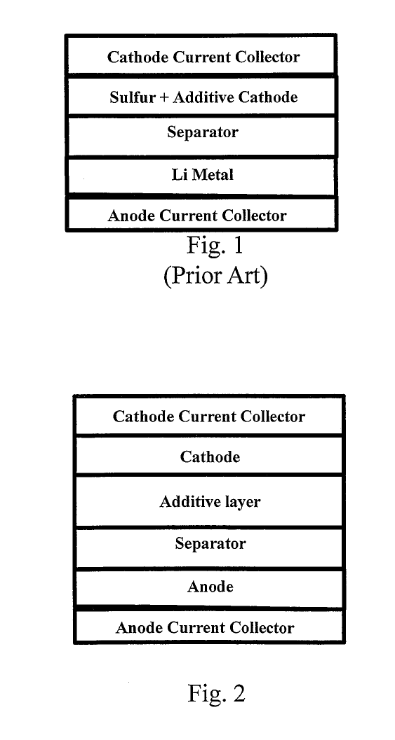

This disclosure provides embodiments of battery cells in which elechtrocehmically an active transition metal sulfide, oxide, or phosphate is an additive in the battery cell. Instead of mixing the additive in with the cathode material as shown in FIG. 1, the additive interacts with the cathode of the battery cell as a discrete layer.

FIG. 2 schematically illustrates an embodiment of a battery cell, and includes a cathode current collector, a cathode, an additive layer, a separator, anode, and an anode current collector.

The cathode current collector is typically a conductive layer that may comprise a non-reactive metal such as silver, gold, platinum or aluminum.

The cathode may be made from a material comprising sulfur. In one embodiment the cathode comprises sulfur. In addition to sulfur the cathode may include at least one of carbon and a fluropolymer. In certain embodiments the carbon may be carbon black. In certain embodiments the fluorpolymer may be polyvinylidene difluoride. In one embodiment the cathode comprises sulfur, carbon black, and polyvinylidene difluoride. In one embodiment the ratio of sulfur:carbon:polyvinylidene difluoride is 60:30:10.

The additive layer is an active interlayer situated between the separator and the cathode and may comprise at least one of a transition metal sulfide, a transition metal oxide, and a transition metal phosphate. In certain embodiments, the additive layer comprises at least one of TiS₂, MnO₂, LiMn₃O₆, LiMn₈O₁₆, V₂O₅, LiV₃O₈, LiFePO₄, or combinations thereof.

A separator such as for example a polyolefin separator may be incorporated with the cell system. The separator may be between the cathode and the anode current collector. In one embodiment, the separator is in direct contact with the additive layer. In one embodiment, the separator is be between the additive layer and the anode.

The anode may be for example silicon, graphite, carbon, graphene, combinations thereof, or any material known to be used for the anode. The carbon may be in the form of for example a nanotube. The anode when supplied with lithium thus may comprise lithium metal, lithiated graphite, or lithium-Si alloy. In certain embodiments, the anode comprises a lithium metal anode, a graphite anode, a silicon anode, a lithiated graphite (LixC6, x<1), a lithiated Silicon (LixSi, x<4.4), or a combination thereof. In one embodiment the anode is lithium metal.

The anode current collector may comprise one or more of a variety of materials that can collect current from the anode, contact the anode without being reduced, and allow alkali ions from the anode to pass therethrough. Some non-limiting examples of suitable anode current collector materials include reduced, or pure, copper, nickel, brass (70% copper, 30% zinc), a suitable cermet material (e.g., a Cu/NaSICON, a Cu/LiSICON, etc.), and one or more other suitable materials.

Additionally, the battery cell may include an electrolyte. The electrolyte suitable in the present cell system may include any electrolyte know in the art. The electrolyte may comprise a liquid, a solid, or a polymer gel-type electrolyte. Specific examples may include but are not limited to a non-aqueous liquid or a solid polymer electrolyte that contains a dissolved lithium salt. In certain embodiments the electrolyte includes a lithium hexafluorophosphate solution in ethylene carbonate and dimethyl carbonate. In one embodiment the electrolyte comprises Lithium bis(trifluoromethanesulfonyl)imide (LiTFSI) in dioxolane and dimethoxyethane (DOL/DME).

Other components of the lithium battery may include an external encapsulating shell, a cathode terminal, and an anode terminal.

This approach allows the use of the conventional and commercially available metal oxide or phosphate cathode materials and additives, contributing to an improved sulfur cell performance without increasing the cost associated with the synthesis and process procedures. In addition, the selected additives are also electrochemically active with higher redox potentials than that of the Sulfur system and contributing to the cell capacity, which partially compensates the gravimetric capacity density lost due to the extra weight introduced by the additive. Furthermore, since these additives have high discharge voltage (within 3V to 4V range), their contribution to the energy density (in Wh/g) is even higher. For a sulfur battery, the typical cycling voltage limit is between 2.6-3.0V (charge) to 1.8V (discharge). Within this voltage range, the selected additives are inert electrochemically—provide no capacity to the overall cell energy density. In this approach, a wider voltage window is used to activate the additive layer, especially during cell charge. Depending on the material, the charge voltage limit can be increased to as high as 4.0V. Due to the oxidative stability of the ether based electrolyte, the upper voltage limit may be controlled no higher than 4.0V or as low as possible to just get the additive cathode activated. Possibilities of using for example metal oxide material with cycling voltage higher than 4.0V also exist when high-voltage stable electrolytes are used, such as Fluoro-substituted ether based solvents or carbonate based solvents.

FIG. 2 shows the present invention that maintains the advantages and minimizes the disadvantages from the prior art designs. With this approach, the positive impact of TiS₂ and metal oxide (for example γ-MnO₂) additive on the Sulfur cell performance is maximized: i) by using the wider cell cycling voltage window the reversible capacity of TiS₂ (1.6V to 2.6V) and γ-MnO₂ (1.6V to 4.0V) is fully utilizable contributing to the cell energy density ii) TiS₂, γ-MnO₂, and carbon included in the TiS₂ or MnO₂ layer can act as the polysulfide absorber either physically or chemically to minimize the shuttling effect of polysulfide intermediate, resulting in high Coulombic efficiency; iii) the discrete layer may act as a physical barrier to slowdown the migration of polysulfide from the cathode to the anode while still allowing the lithium ion diffusion; iv) due to the electronic conductivity nature of the transition metal sulfides or the Li-ion conductive ability of the transition metal oxide composite, the TiS₂ or MnO₂ discrete layer can act as a conductive pathway for Li₂S (the discharge product of Sulfur electrode), which were deposited on the surface of the cathode matrix during polysulfide reduction, to be re-oxidized more efficiently for higher sulfur utilization in the subsequent charge cycles, leading to higher sulfur utilization for high energy density and long cycle life; v) the presence of discrete conductive TiS₂ or MnO₂ composite layer on the top of the Sulfur cathode may allow the usage of high sulfur electrode loading with higher active Sulfur % cathode formulation, resulting in higher cell energy density and low cost; vi) under the charged state, the high electrochemical potential of the MnO₂ additive may facilitate the conversion of soluble polysulfide into the insoluble sulfur which helps to maintain Sulfur electrode stability with minimized self-discharge. Furthermore, the presence of a discrete TiS₂ layer on the top of the Sulfur electrode, the Sulfur utilization can be improved from ˜40-50% to up to ˜70-80%—a net 30% improvement from ˜670-837 mAh/g to 1172-1339 mAh/g as shown in the following examples.

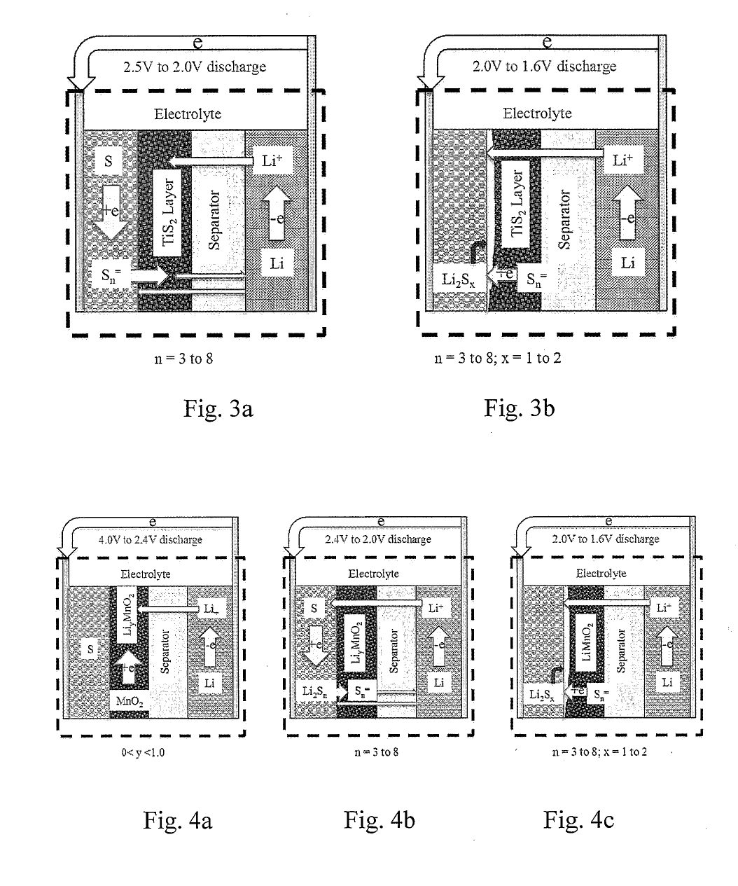

The mechanism of cell cycling for an embodiment using a discrete TiS₂ additive layer is schematically described in FIG. 3. FIG. 3a demonstrates the 1^{st} step sulfur discharge between 2.5V to ˜2.0V where electrolyte soluble polysulfide intermediates Li₂Sₙ (n=8 to 3) are formed. At this stage, the polysulfide products dissolve in the electrolyte and migrate out of the sulfur cathode matrix and diffuse into the TiS₂ composite layer that contains TiS₂ (or partially reduced TiS₂), carbon additive and binder. The polysulfide will interact with TiS₂ and carbon to be absorbed either physically or chemically. Depending on the efficiency of the TiS₂ layer and polysulfide interaction, small amount of polysulfide can still pass through the TiS₂ and the separator layers to reach the anode surface. In this situation, partial shuttling effect could still exist, but with the reduced scope. During this stage, TiS₂ will also be partially reduced to produce Li_{1-z}TiS₂ (0<z<1) and contribute capacity to the cell discharge. FIG. 3b shows the 2^{nd} stage discharge from 2.0V to 1.6V, where the high order soluble polysulfide intermediates (n=8 to 3) are further reduced to the low order insoluble polysulfide products (x=2 to 1) which deposit on the surface of the cathode and the TiS₂ layer, especially on the electrolyte/Sulfur cathode interface. The final product is Li₂S (x=1), which is an insulator and insoluble in electrolyte. At this stage, the partially discharged Li_{1-z}TiS₂ (0<z<1) will be fully discharged to LiTiS₂. Due to the insulating nature of Li₂S, the additional Sulfur or polysulfide reduction on the cathode surface could be blocked in a regular Sulfur cell, resulting in low Sulfur utilization. However, the discrete conductive TiS₂ layer in current design, which is in direct contact with the sulfur cathode, provides an alternative electron conduction pathway to the Li₂S covered cathode interface for additional sulfur and polysulfide reduction, leading to the improved sulfur utilization.

During the cell charging, the above processes are just reversed. Again, due to the electronic and ionic conductive nature of the TiS₂ discrete layer, the efficiency of Li₂S oxidation to polysulfide intermediate and then to sulfur can be improved. At the same time, the LiTiS₂ will be charged to TiS₂ providing extra cell capacity.

The mechanism of cell cycling for an embodiment using a discrete γ-MnO₂ additive layer is schematically described in FIG. 4. FIG. 4a demonstrates the 1^{st} step MnO₂ discharge between 4.0V to 2.4V where γ-MnO₂ is lithiated to form Li_{y}MnO₂ (0<y<1) contributes to the cell discharge energy density. Due to the high potentials, Sulfur electrode is not discharged at this stage. FIG. 4b demonstrates the 2^{nd} step discharge between 2.4V to ˜2.0V where electrolyte soluble polysulfide intermediates Li₂Sₙ(n=8 to 3) are formed. At this stage, the polysulfide products dissolve in the electrolyte and partially diffuse into the MnO₂ composite layer that contains γ-MnO₂, carbon additive and binder. The polysulfide will interact with Li_{y}MnO₂ and carbon to be absorbed either physically or chemically. The chemical interaction between polysulfide and lithiated γ-MnO₂ may form S—SO₃ bond that immobilizes the polysulfide and thus prevents the polysulfide diffusion to the anode surface. If the insufficient MnO₂ material was present, small amount of polysulfide could still pass through the Li_{y}MnO₂ and the separator layers to reach the anode surface. In this situation, partial shuttling effect could still exist but with the reduced scope. FIG. 4c shows the 3^{rd} stage discharge from 2.0V to 1.6V, where the high order soluble polysulfide intermediates (n=3 to 8) are further reduced to the low order insoluble polysulfide products (x=1 to 2) that deposit on the surface of the cathode and the LiMnO₂ layer, especially on the electrolyte/Sulfur cathode interface. The final product is Li₂S (x=1), which is an insulator and insoluble in electrolyte. At this stage, the partially discharged LiyMnO₂ (0<y<1) will be fully discharged to LiMnO₂. Due to the insulating nature of Li₂S, the additional Sulfur or polysulfide reduction on the cathode surface could be blocked in a regular Sulfur cell, resulting in low Sulfur utilization. However, the discrete conductive MnO₂ layer in current design, which is in direct contact with the sulfur cathode, provides an alternative electron and Li-ion conduction pathway to the Li₂S covered cathode interface for additional sulfur and polysulfide reduction, leading to the improved sulfur utilization. In addition, the chemical interaction of MnO₂ layer with dissolved polysulfide provides another mechanism to reduce the shuttling effect besides a physical barrier for polysulfide diffusion.

During the cell charging, the above processes are just reversed. Again, due to the electronic and ionic conductive nature of the MnO₂ discrete layer, the efficiency of Li₂S oxidation to polysulfide intermediate and then to sulfur can be improved. At the same time, the LiMnO₂ will be charged to LiMn₃O₆²⁴ to the charge voltage of up to 4.0V providing extra cell capacity for the subsequent cycles.

### EXAMPLE 1

### Control Cathode and Hybrid Cathode

All chemicals used in this example were used as they were received without further purification. To make a hybrid cathode and a control cathode, Sulfur, TiS₂, Super C65 conductive carbon black, and polyvinylidene difluoride (PVDF) (5 wt % in N-methyl-2-pyrrolidone (NMP)) were combined according to the weight ratios given in Table 1 and mixed thoroughly in a mortar and pestle to form a uniform mixture.

TABLE 1

| | | | Carbon | PVDF |
|---|---|---|---|---|
| | Sulfur | TiS₂ | (weight | (weight |
| Example | (weight ratio) | (weight ratio) | ratio) | ratio) |
| Control Cathode | 60 | 0 | 30 | 10 |
| (Sulfur cathode) | | | | |
| Hybrid Cathode | 60 | 20 | 30 | 10 |
| (Sulfur Cathode | | | | |
| mixed with | | | | |
| TiS₂ additive) | | | | |

NMP was added to the mixture which was further homogenized until a uniform slurry was obtained. After a uniform slurry was obtained, the slurry was coated onto an aluminum foil with a doctor blade, and the coated sample was dried in air for 24 hours, followed by another 24 hours in a vacuum oven at 50° C. Each dried sample punched into two 1.27 cm² disks to be used as electrodes. CR2032 sized coin cells were assembled with the punched cathode, a lithium foil as counter electrode, polypropylene membrane as separator, and (LiTFSI) in DOL/DME (1:1 volume %) electrolyte. The cells were tested with an Arbin electrochemical station in Galvanostatic mode. The current density was chosen to be C/5 and the voltage range was set between 2.6 and 1.6V.

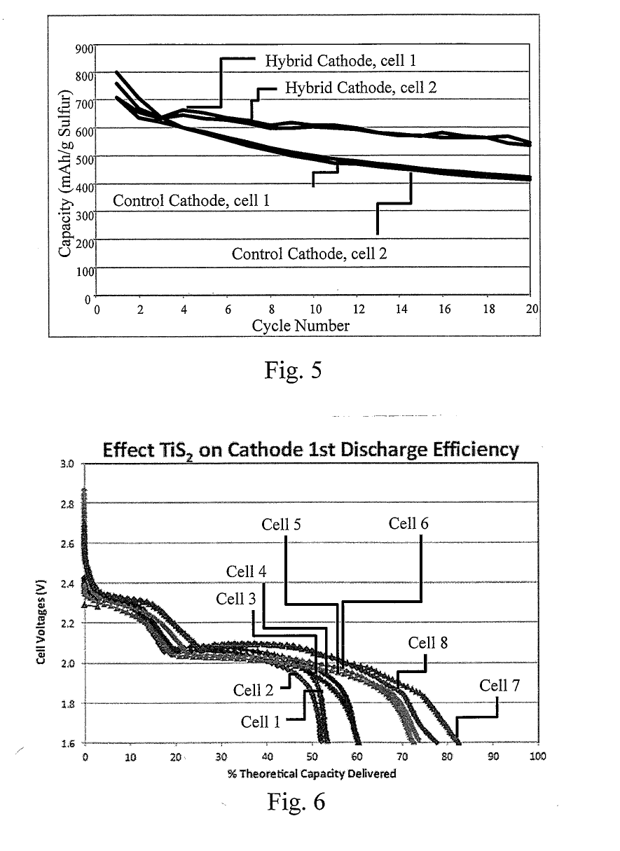

FIG. 5 is a graph showing the cell cycling discharge capacities vs. the cycle number for the coin cells using the Control Cathode or the Hybrid Cathode. The discharge capacity is normalized by the Sulfur weight within the cathode. The data show a benefit effect of S:TiS₂ hybrid cathode cells over the control cell in terms of lower cycling capacity fade. However, the initial discharge capacity for both cases are very similar (between 700-800 mAh/g Sulfur or 42-48% Sulfur utilization)—indicating no improvement in Sulfur utilization by just physically mixing TiS₂ in the Sulfur electrode.

### EXAMPLE 2

### TiS₂ Discrete Layer over Sulfur Cathode

Sulfur cathodes (Control Cathode) were produced as in Example 1. TiS₂ in NW slurry was coated on a polypropylene membrane to form a discrete layer. This discrete TiS₂ layer on membrane was then assembled within the cell stack with the TiS₂ side facing the Sulfur cathode and in direct contact with the Sulfur cathode as shown in FIG. 2 and FIG. 3. The formulation of Sulfur electrode and the discrete TiS₂ layer is fixed as: Active (either S or TiS2):Carbon:PVDF=60:30:10. The theoretical capacity ratio between Sulfur and TiS₂ can be adjusted by modifying the loading of either Sulfur cathode or coated TiS₂ layer on the separator. Examples of this ratio change are shown in Table 2 below.

TABLE 2

| | | Capacity % |
|---|---|---|
| Coin Cell # | TiS₂ Discrete Layer | (TiS₂/[S + TiS₂]) |
| 1 Control Cathode | No | 0 |
| 2 Control Cathode | No | 0 |
| 3 | Yes | 3.7 |
| 4 | Yes | 4.5 |
| 5 | Yes | 16 |
| 6 | Yes | 17.5 |
| 7 | Yes | 23.1 |
| 8 | Yes | 25.5 |

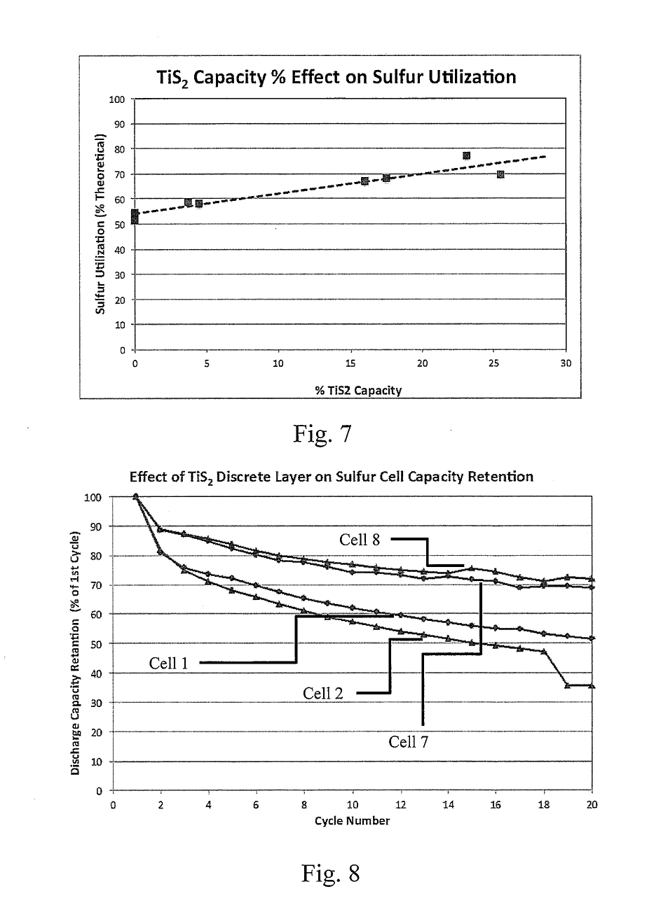

The cells were discharge/charge cycled under C/5 rate (based on the total S+TiS₂ capacity). The cell discharge voltage profiles against the percent delivered capacity (theoretical cell capacity=100%) are shown in FIG. 6. All cells with the discrete TiS₂ layer resulted in higher active cathode material utilization than the Sulfur only cells. The majority of this cathode efficiency improvement may be due to the higher sulfur discharge efficiency as show in FIG. 7.

In FIG. 7, it is assumed that the TiS₂ material delivers 100% of its theoretical capacity. By subtracting this value from the total cell capacity, the sulfur electrode utilization in all cases can be estimated as shown in FIG. 7 with a linear relationship against the % TiS₂ capacity. The more relative amount of TiS₂, the higher the Sulfur utilization will be realized. The Sulfur utilization is improved from ˜50% for the control cell to up to ˜80% within this experiment. If TiS₂ discharge efficiency is less than 100%, then the Sulfur utilization could be even higher than the projected value. The cycling capacity retention of the control cells (Cells 1 and 2) vs. the cells with high TiS₂ capacity ratio (Cells 7 and 8) is shown in FIG. 8. Similar to Example 1 (Hybrid Cathode, Sulfur Cathode mixed with TiS₂ additive), cells with TiS₂ coated separator design exhibited lower capacity fade.

As seen in these examples, sulfur utilization improvement may be achieved by using a discrete layer of TiS₂ (Cells 3-8). Using hybrid cathodes alone (Sulfur Cathode mixed with TiS₂ additive), as demonstrated in Example 1, does not realize this improvement, indicating the Sulfur cathode/electrolyte interface may play a part of the positive S—TiS₂ interaction. The presence of electronic and ionic conductive TiS₂ layer at the Sulfur cathode and electrolyte interface may facilitate the conversion of soluble polysulfide reduction to form the insoluble lithium sulfide final product.

### Example 3

### γ-MnO₂ cathode

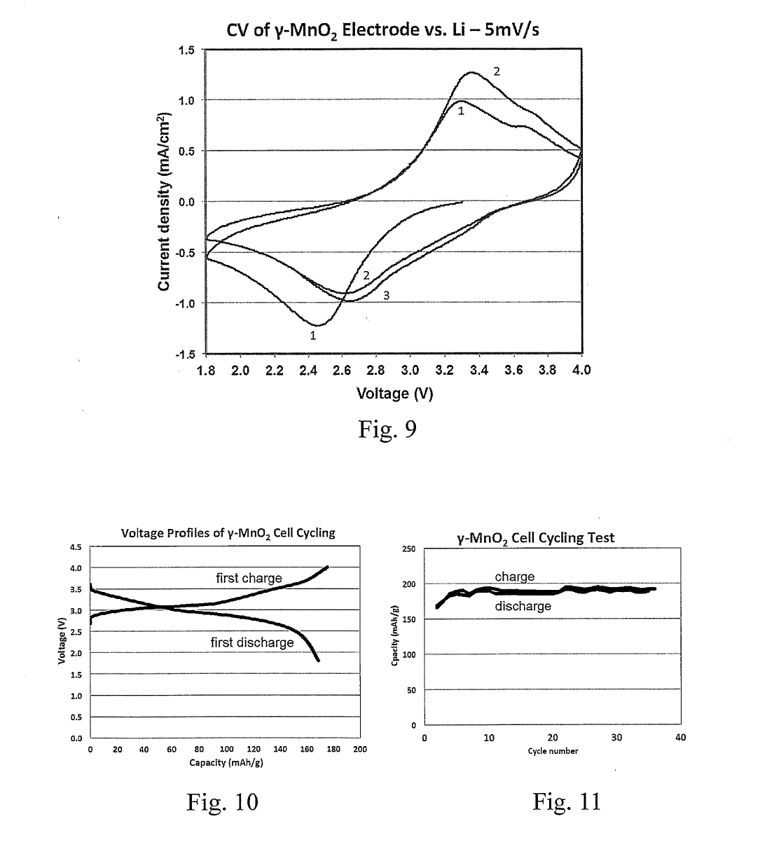

γ-MnO₂ material electrochemical performance was tested by preparing a γ-MnO₂ cathode. The γ-MnO₂ cathode was prepared by mixing γ-MnO₂ with Super C65 conductive carbon black and PVDF binder in the weight ratio of 85:10:5 in a slurry using NMP as solvent. The electrode was tape casted on Al foil and air dried for 24 hours inside a dry room (maximum dew point −40° C.), then dried at 50° C. in an oven for 24 hours. Coin cells with lithium as anode and 1.0M LiTFSI in DOL:DME=1:1 v/v ratio containing 1 wt % +LiNO₃ as electrolyte were prepared in order to simulate the chemical environment of Sulfur battery. FIG. 9 shows the cyclic voltammetry (CV) performed on a coin cell with γ-MnO₂ cathode. The numbers 1, 2, and 3 in the figure indicates cycle 1, 2, and 3 respectively.

The CV data indicate the reversible cycling of the γ-MnO₂ electrode within the voltage window of 1.8V to 4.0V vs. Li/Li⁺. It also indicates the increasing of the rate capability of this material upon cycles with current density increased from cycle 1 to cycle 2 for charging and from cycle 2 to cycle 3 for discharging. In both cases, the peak potential position also shifted to a higher voltage value. After the above CV test, the cell was placed on cycling test by discharge and charge under ˜0.6C rate. The 1^{st} cycle discharge and charge voltage profiles are shown in FIG. 10. The sloped voltage profiles are observed for both discharge and charge. FIG. 11 presents the cell cycling behavior over 35 cycles. Clearly, the cycling capacity increased in the initial 5 cycles that is consistent with the CV data. The cell cycling is very reversible with delivered discharge capacities stabilized at ˜190 mAh/g. This test indicates that γ-MnO₂ can be cycled reversibly within the ether-based electrolyte (same as used for Sulfur batteries) between 1.8V to 4.0V. Under this discharge condition, the MnO₂ electrode delivered 92% of its theoretical capacity (205 mAh/g assuming 0.67 Li intercalation) if the reversible reaction follows the following equation.

LiMn₃O₆+2Li [symbol] 3LiMnO₂

### Example 4

### γ-MnO₂ Discrete Layer Over Sulfur Cathode

γ-MnO₂ was coated on a polyolefin separator to form a discrete layer with a formulation as in Example 3. This discrete γ-MnO₂ layer was then assembled within a cell stack with the γ-MnO₂ side facing the Sulfur cathode and in direct contact with the Sulfur cathode as shown in FIG. 2 and FIG. 4. For comparison, the Sulfur cathode formulation is fixed as: S:Carbon:PVDF=60:30:10 for both control cells and the layered testing cells. To check the electrode design effect, a coin cell using the hybrid mixture of Sulfur and γ-MnO₂ was prepared and tested using formulation of S:MnO₂:Carbon:PVDF=30:40:20:10 to match the active material ratio used for the discrete layer cells. The coin cell construction information and the testing voltage limit for each coin cell are summarized in Table 3.

TABLE 3

| | | | | Cell Theoretic Capacity | | | % | |
|---|---|---|---|---|---|---|---|---|
| | | Sulfur | γ-MnO₂ | (mAh) | | | Theoretical | Cell Testing |
| | γ-MnO₂ | Loading | Loading | | γ- | Total | Capacity | Voltae |
| Cell # | layer | (mg/cm²) | (mg/cm²) | Sulfur | MnO₂ | Cell | by γ-MnO₂ | Range |
| 1 | Yes | 1.13 | 0.80 | 2.39 | 0.42 | 2.81 | 14.9% | 1.8 V-4.0 V |
| 2 | Yes | 1.21 | 0.71 | 2.56 | 0.37 | 2.94 | 12.6% | 1.8 V-4.0 V |
| 3 | No | 1.34 | 0.00 | 2.84 | 0.00 | 2.84 | 0.0% | 1.8 V-2.6 V |
| 4 | No | 1.12 | 0.00 | 2.37 | 0.00 | 2.37 | 0.0% | 1.8 V-2.6 V |
| 5 | Mixture | 0.90 | 1.20 | 1.91 | 0.31 | 2.22 | 14.0% | 1.8 V-4.0 V |

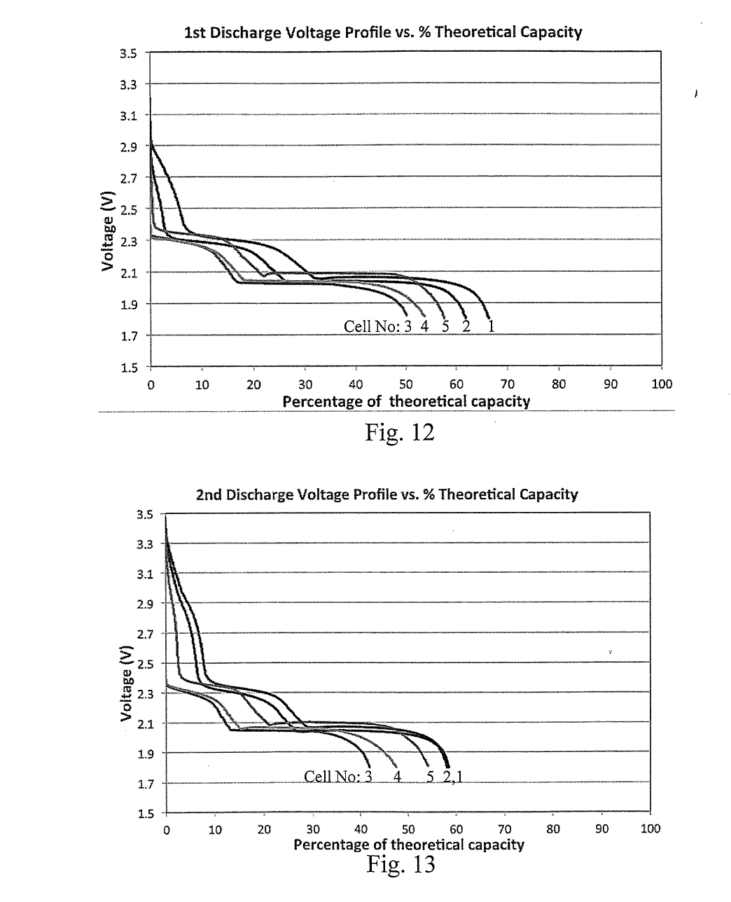

The first discharge voltage profiles vs. the theoretical capacity are shown in FIG. 12. For control cells (cells 3 and 4), a typical sulfur cell voltage profile is shown—one voltage plateau at ˜2.3V represents sulfur reduction to polysulfide and a 2^{nd} voltage plateau at ˜2.1V represents the reduction of polysulfide to form Li₂S₂ and LiS₂. Under C/5 discharge rate, the control cells delivered ˜52% of the theoretical capacity. However, the cells with the discrete MnO₂ layer (cells 1 and 2) showed 3 distinct voltage plateau regions. The 1^{st} discharge voltage region at ˜3.0V representing the formation of Li_{y}MnO₂ where 0<y<1. The 2^{nd} and the 3^{rd} voltage plateaus represent the sulfur cell discharge as described above. The hybrid mixture cell (cell 5) also showed similar voltage profiles as cells 1 and 2. To clearly show the MnO₂ discharge voltage plateau, the 2^{nd} cycle discharge voltage profiles of all the cells are shown in FIG. 13. Overall, the cells with discrete MnO₂ layer delivered an average of ˜64% of its theoretical capacity, while the hybrid cell delivered 57% of its theoretical capacity in the 1^{st} discharge. Assuming the MnO₂ portion of the cathode delivered 100% of its theoretical capacity (205 mAh/g), the worst case Sulfur utilization for the layered cells and hybrid mixture cell can be estimated as shown in Table 4. For both the 1^{st} and 2^{nd} discharges, the mixture cell (cell 5) delivered the same Sulfur utilization as control Sulfur cells (cells 3 and 4). While for cell 1 and cell 2 with discrete MnO₂ layer, higher Sulfur utilization (˜5% or ˜84 mAh/g Sulfur) is observed. Considering this as the worst-case scenario, the % improvement could be much higher if MnO₂ did not deliver 100% of its theoretical capacity.

TABLE 4

| | | Capacity | | Sulfur Utilization (% | |
|---|---|---|---|---|---|
| Cell | γ-MnO₂ | by Sulfur (mAh/g) | | Theoretical) | |
| # | layer | 1^{st} discharge | 2^{nd} discharge | 1^{st} discharge | 2^{nd} discharge |
| 1 | Yes | 1013 | 859 | 61 | 51 |
| 2 | Yes | 943 | 872 | 56 | 52 |
| 3 | No | 843 | 700 | 50 | 42 |
| 4 | No | 904 | 795 | 54 | 47 |
| 5 | Mixture | 848 | 785 | 51 | 47 |

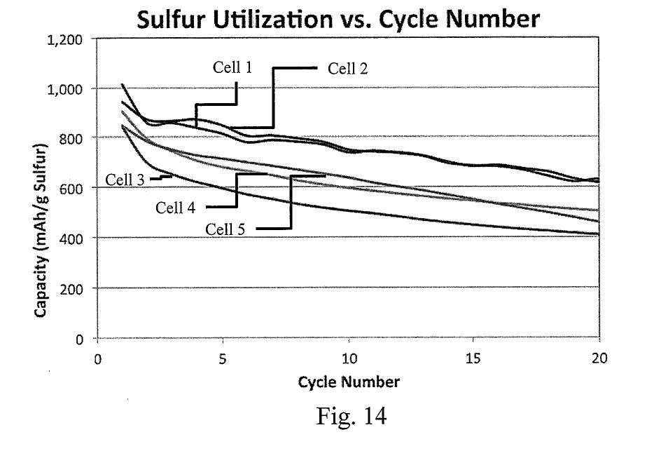

For comparison, the sulfur utilization vs. the cycle number for all the cells is shown in FIG. 14. The data indicate that the cells with the γ-MnO₂ discrete layer maintain higher Sulfur utilization than the Sulfur control cells throughout the cycling test; while the hybrid mixture cell exhibited similar Sulfur utilization.

The above examples demonstrate the use of discrete γ-MnO₂ layer on top of Sulfur electrode to promote Sulfur utilization and improve the cell cycle life. This higher Sulfur utilization cannot be achieved by just mixing Sulfur with the MnO₂ in a hybrid electrode design as demonstrated here. In addition, the widening of the cell cycling voltage window allows the γ-MnO₂ to be electrochemically active as shown here, contributing to the deliverable cell energy density that compensate the gravimetric energy density lost due to the extra weight introduced by γ-MnO₂ discrete layer. The improved cell cycling results also demonstrate the compatibility of γ-MnO₂ and the ether-based electrolyte within the charge-discharge voltage window.

1. A battery cell system comprising:
an anode current collector in contact with an anode;
a separator in contact with the anode;
an electrolyte;
a cathode;
an additive layer situated between the separator and the cathode, wherein the additive layer comprises at least one of a transition metal sulfide, a transition metal oxide, and a transition metal phosphate; and
a cathode current collector in contact with the cathode.

2. The battery cell system of claim 1, wherein the anode comprises a lithium metal anode, a graphite anode, a silicon anode, a lithiated graphite (LixC6, x<1), a lithiated Silicon (LixSi, x<4.4), or a combination thereof

3. The battery cell system of claim 1, wherein the anode comprises a lithium metal anode.

4. The battery cell system of claim 3, wherein the cathode comprises sulfur.

5. The battery cell system of claim 1, wherein additive layer comprises at least one of TiS₂, MnO₂, LiMn₃O₆, LiMn₈O₁₆, V₂O₅, LiV₃O₈, or LiFePO₄.

5. The battery cell system of claim 1, wherein additive layer comprises γ-MnO₂.

6. The battery cell system of claim 1, wherein additive layer comprises TiS₂.

7. The battery cell system of claim 6, wherein the separator comprises a polypropylene membrane.
